(19) United States
(12) Patent Application Publication
(10) Pub. No.: US 2015/0163464 A1
(43) Pub. Date: Jun. 11, 2015

(54) SOLID-STATE IMAGING DEVICE

(71) Applicant: Kabushiki Kaisha Toshiba, Minato-ku (JP)

(72) Inventors: Yoshitaka EGAWA, Yokohama (JP); Hirofumi Yamashita, Kawasaki (JP); Ai Shimomura, Yokohama (JP)

(73) Assignee: Kabushiki Kaisha Toshiba, Minato-ku (JP)

(21) Appl. No.: 14/456,061

(22) Filed: Aug. 11, 2014

(30) Foreign Application Priority Data
Dec. 9, 2013 (JP) 2013-254037

(51) Int. Cl. H04N 9/04; H04N 5/369; H04N 5/359

(52) U.S. Cl. CPC H04N 9/045; H04N 5/359; H04N 5/369

(57) ABSTRACT

According to one embodiment, a pixel array unit includes a matrix of first and second two-pixel green photoelectric conversion layers that are arranged obliquely with respect to a column direction, a two-pixel blue photoelectric conversion that is arranged adjacent to the first and second green photoelectric conversion layers, and a red photoelectric conversion layer that overlaps the blue photoelectric conversion layer in a depth direction. A green filter that is provided consecutively for two pixels on the first and second green photoelectric conversion layers, and a magenta filter or a white filter is provided consecutively for two pixels on the blue photoelectric conversion layer.

### CROSS-REFERENCE TO RELATED APPLICATIONS

This application is based upon and claims the benefit of priority from Japanese Patent Application No. 2013-254037, filed on Dec. 9, 2013; the entire contents of which are incorporated herein by reference.

### FIELD

Embodiments described herein relate generally to a solid-state imaging device.

### BACKGROUND

In recent years, there has been an increasing demand for thinner and higher-resolution camera modules to be mounted in mobile phones and the like. In correspondence with such thinner and higher-resolution camera modules, image sensors have had finer pixels. In an image sensor, a smaller amount of light enters pixels with a smaller pixel area, and thus the amount of signals decreases and the signal-to-noise ratio (SNR) deteriorates. Accordingly, the realization of higher-sensitive image sensors with improvement of light use efficiency is desired.

### BRIEF DESCRIPTION OF THE DRAWINGS

FIG. 1 is a schematic block diagram of a solid-state imaging device according to a first embodiment;

FIG. 2 is a circuit diagram illustrating a two-pixel one-cell configuration of a Bayer array in the solid-state imaging device illustrated in FIG. 1;

FIG. 3 is a plane view of a layout example of color filters in the solid-state imaging device according to the first embodiment;

FIG. 4A is a plane view of a layout example of microlenses in the solid-state imaging device according to the first embodiment, and FIG. 4B is a plane view of another layout example of microlenses in the solid-state imaging device according to the first embodiment;

FIG. 5 is a plane view of a layout example of photodiodes, floating diffusions, and gate electrodes in the solid-state imaging device according to the first embodiment;

FIG. 6 is a plane view of another layout example of photodiodes, floating diffusions, and gate electrodes in the solid-state imaging device according to the first embodiment;

FIG. 7 is a schematic cross-sectional view of a configuration example of the solid-state imaging device taken along green filters illustrated in FIG. 3;

FIG. 8 is a schematic cross-sectional view of a configuration example of the solid-state imaging device taken along magenta filters illustrated in FIG. 3;

FIG. 9 is a schematic cross-sectional view of another configuration example of the solid-state imaging device taken along magenta filters illustrated in FIG. 3;

FIG. 10A is a plane view of a layout example of color filters in a solid-state imaging device according to a second embodiment, and FIG. 10B is a plane view of a layout example of microlenses in the solid-state imaging device according to the second embodiment;

FIG. 11 is a schematic cross-sectional view of a configuration example of the solid-state imaging device taken along magenta filters illustrated in FIG. 10A;

FIG. 12A is a plane view of a layout example of color filters in a solid-state imaging device according to a third embodiment, and FIG. 12B is a plane view of another layout example of color filters in the solid-state imaging device according to the third embodiment;

FIG. 13 is a schematic cross-sectional view of another configuration example of the solid-state imaging device taken along a white filter and a green filter illustrated in FIG. 12A;

FIG. 14 is a schematic cross-sectional view of another configuration example of the solid-state imaging device taken along a white filter and a green filter illustrated in FIG. 12A;

FIG. 15A is a plane view of a layout example of color filters in a solid-state imaging device according to a fourth embodiment, and FIG. 15B is a plane view of a layout example of microlenses in a solid-state imaging device according to a fifth embodiment;

FIG. 16 is a plane view of a layout example of photodiodes, floating diffusions, and gate electrodes corresponding to the layout of color filters illustrated in FIG. 15B;

FIG. 17A is a plane view of a layout example of microlenses corresponding to the color filter array illustrated in FIG. 15A or 15B, FIG. 17B is a plane view of another layout example of microlenses corresponding to the color filter array illustrated in FIG. 15A, and FIG. 17C is a plane view of another layout example of microlenses corresponding to the color filter array illustrated in FIG. 15B;

FIG. 18A is a plane view of a layout example of color filters in a solid-state imaging device according to a sixth embodiment, and FIG. 18B is a plane view of a layout example of microlenses in the solid-state imaging device according to the sixth embodiment;

FIG. 19 is a circuit diagram illustrating a four-pixel one-cell configuration example of a Bayer array in a solid-state imaging device according to a seventh embodiment;

FIG. 20 is a circuit diagram illustrating another four-pixel one-cell configuration example of a Bayer array in the solid-state imaging device according to the seventh embodiment;

FIG. 21 is a plane view of a layout example of photodiodes, floating diffusions, and gate electrodes in the solid-state imaging device according to the seventh embodiment;

FIG. 22 is a plane view of a layout example of photodiodes, floating diffusions, and gate electrodes in a solid-state imaging device according to an eighth embodiment;

FIG. 23 is a plane view of a layout example of photodiodes, floating diffusions, and gate electrodes in a solid-state imaging device according to a ninth embodiment;

FIG. 24 is a schematic block diagram of a digital camera to which a solid-state imaging device according to a tenth embodiment is applied; and

FIG. 25 is a schematic cross-sectional view of a camera module to which a solid-state imaging device according to an eleventh embodiment is applied.

### DETAILED DESCRIPTION

In general, according to one embodiment, a solid-state imaging device is provided with a pixel array unit, green filters, and magenta filters or white filters. The pixel array unit has a matrix of first and second two-pixel green photoelectric conversion layers that are arranged obliquely with respect to a column direction, two-pixel blue photoelectric conversion layers that are arranged adjacent to the first and second green photoelectric conversion layers, and red photoelectric conversion layer that overlap the blue photoelectric conversion layers in a depth direction. The green filters are provided consecutively for two pixels on the first and second green photoelectric conversion layers. The magenta filters or the white filters are provided consecutively for two pixels on the blue photoelectric conversion layers.

Exemplary embodiments of the solid-state imaging device will be explained below in detail with reference to the accompanying drawings. The present invention is not limited to the following embodiments.

### First Embodiment

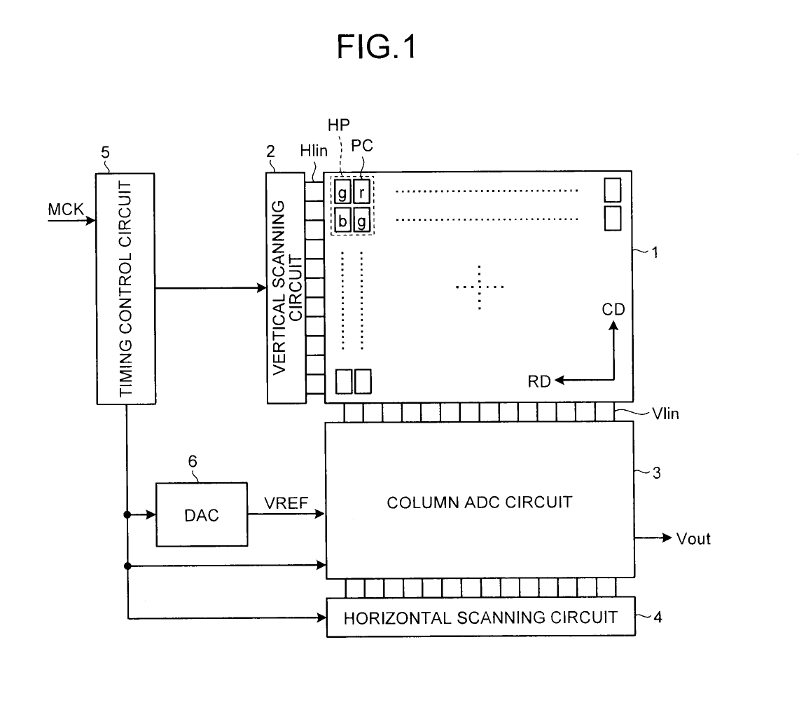

FIG. 1 is a schematic block diagram of a solid-state imaging device according to a first embodiment.

Referring to FIG. 1, the solid-state imaging device is provided with: a pixel array unit 1 in which pixels PC for accumulating photoelectric-converted charges are arranged in a matrix with rows and columns; a vertical scanning circuit 2 that vertically scans the pixels PC to be read; a column ADC circuit 3 that detects by CDS signal components of the pixels PC; a horizontal scanning circuit 4 that horizontally scans the pixels PC to be read; a timing control circuit 5 that controls reading of the pixels PC and timing of accumulation; and a reference voltage generation circuit 6 that outputs a reference voltage VREF to the column ADC circuit 3. A master clock MCK is input into the timing control circuit 5.

The pixel array unit 1 is provided with horizontal control wires Hlin that control reading of the pixels PC in a row direction RD, and vertical signal wires Vlin that transmits signals read from the pixels PC in a column direction CD.

In a Bayer array HP of the 1, two green pixels g are arranged in one diagonal direction, and a red pixel r and a blue pixel b are arranged to obtain signals from one red pixel r and one blue pixel b from a pixel position in the other diagonal direction. At that time, the 1 can have arranged a matrix of first and second two-pixel green photoelectric conversion layers arranged obliquely with respect to the column direction CD, a two-pixel blue photoelectric conversion layer arranged adjacent to the first and second green photoelectric conversion layers, and a red photoelectric conversion layer overlapping the blue photoelectric conversion layer in a depth direction. The green filters can be provided consecutively for two pixels on the first and second green photoelectric conversion layers. The magenta filters or the white filters can be provided consecutively for two pixels on the blue photoelectric conversion layer.

Then, when the pixels PC are vertically scanned by the vertical scanning circuit 2, the pixels PC are selected in the row direction and signals read from the pixels PC are sent to the column ADC circuit 3 via the vertical signal wires Vlin. Then, differences between signal levels of the signals read from the pixels PC and a reference level are determined to detect by CDS signal components of the pixels PC in each of the columns, and the detected signal components are output as AD-converted digital output signals Vout.

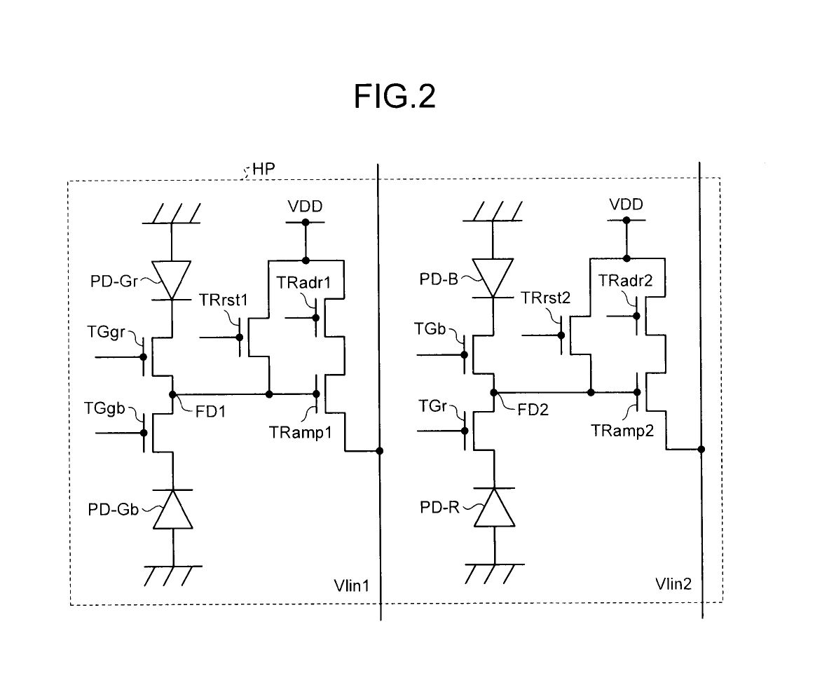

FIG. 2 is a circuit diagram illustrating a two-pixel one-cell configuration of a Bayer array in the solid-state imaging device illustrated in FIG. 1.

Referring to FIG. 2, the Bayer array HP is provided with photodiodes PD-B, PD-R, PD-Gr, and PD-Gb, row selection transistors TRadr1 and TRadr2, amplification transistors TRamp1 and TRamp2, reset transistors TRrst1 and TRrst2, and read transistors TGb, TGr, TGgr, and TGgb. In addition, a floating diffusion FD1 is formed as a detection node at a connection point of the amplification transistor TRamp1, the reset transistor TRrst1, and the read transistors TGgr and TGgb. A floating diffusion FD2 is formed as a detection node at a connection point of the amplification transistor TRamp2, the reset transistor TRrst2, and the read transistors TGb and TGr. The floating diffusion FD1, the row section transistor TRadr1, the amplification transistor TRamp1, and the reset transistor TRrsL1 are shared by the photodiodes PD-Gr and PD-Gb. The floating diffusion FD2, the row selection transistor TRadr2, the amplification transistor TRamp2, and the reset transistor TRrst2 are shared by the photodiodes PD-B and PD-R. The read transistors TGb, TGr, TGgr, and TGgb are provided for the photodiodes PD-B, PD-R, PD-Gr, and PD-Gb, respectively.

A source of the read transistor TGgr is connected to the photodiode PD-Gr, a source of the read transistor TGb is connected to the photodiode PD-B, a source of the read transistor TGr is connected to the photodiode PD-R, and a source of the read transistor TGgb is connected to the photodiode PD-Gb. In addition, a source of the reset transistor TRrst1 is connected to drains of the read transistors TGgr and TGgb, a source of the reset transistor TRrst2 is connected to drains of the read transistors TGb and TGr, drains of the reset transistors TRrst1 and TRrst2 and the row selection transistors TRadr1 and TRadr2 are connected to a power source potential VDD. In addition, a source of the amplification transistor TRamp1 is connected to the vertical signal line Vlin1, and a gate of the amplification transistor TRamp1 is connected to the drains of the read transistors TGgr and TGgb, a drain of the amplification transistor TRamp1 is connected to a source of the row selection transistor TRadr1. A source of the amplification transistor TRamp2 is connected to the vertical signal line Vlin2, a gate of the amplification transistor TRamp2 is connected to drains of the read transistors TGb and TGr, and a drain of the amplification transistor TRamp2 is connected to a source of the row selection transistor TRadr2.

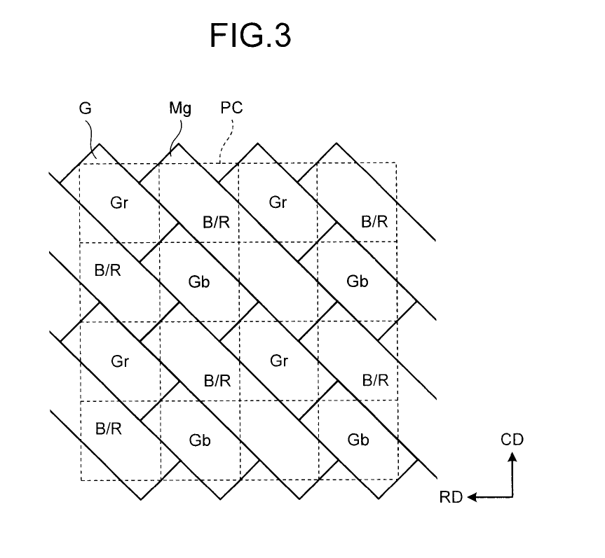

FIG. 3 is a plane view of a layout example of color filters in the solid-state imaging device according to the first embodiment.

Referring to FIG. 3, as the green pixels g illustrated in FIG. 1, green pixels Gr and Gb are provided, and as the red pixels r and blue pixels b, red pixels R and blue pixels B are provided. The blue pixels B overlap the red pixels R. The red pixels R and the blue pixels B are arranged obliquely at longer sides with respect to the column direction CD. For example, the longer sides of the green pixels Gr and Gb, the red pixels R, and the blue pixels B can be set at a 45-degree angle with respect to the column direction CD. The green pixels Gr and Gb are arranged along the short sides of the red pixels R and the blue pixels B. The green pixels Gr and Gb can be alternately arranged in the same lines. The red pixels R and the blue pixels B can be arranged in the same lines. The lines in which the green pixels Gr and Gb are arranged and the lines in which the red pixels R and the blue pixels B are arranged, can be alternately arranged. Area of one pixel PC can be assigned to each of the green pixels Gr and Gb, and area of two pixels PC can be assigned to each of the red pixels R and the blue pixels B. Magenta filters Mg are arranged on the red pixels R and the blue pixels B, and green filters G are arranged on the green pixels Gr and Gb.

By arranging the red pixels R and the blue pixels B obliquely at the longer sides with respect to the column direction CD and arranging the green pixels Gr and Gb along the shorter sides of the red pixels R and the blue pixels B, it is possible to increase the areas of the red pixels R and the blue pixels B over two pixels each without decreasing the areas of the green pixels Gr and Gb, and improve sensitivity while suppressing color mixture.

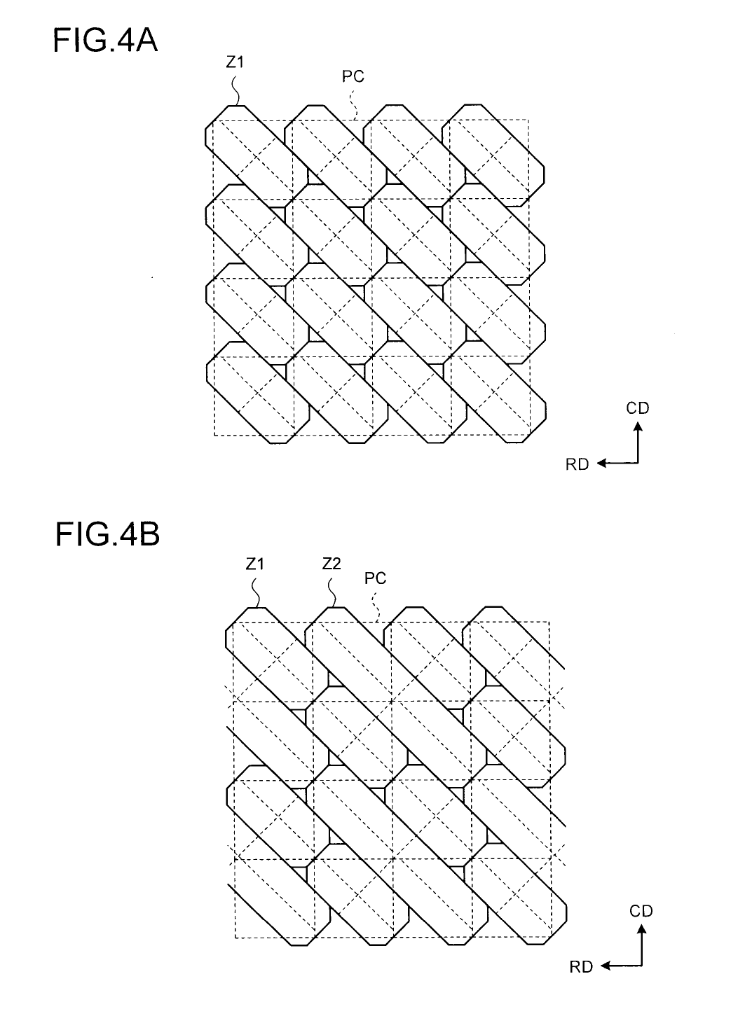

FIG. 4A is a plane view of a layout example of microlenses in the solid-state imaging device according to the first embodiment, and FIG. 4B is a plane view of another layout example of microlenses in the solid-state imaging device according to the first embodiment.

Referring to FIG. 4A, one microlens Z1 each is provided for the green pixels Gr and Gb, and two microlenses Z1 each are provided in common for the red pixel R and the blue pixel B. Accordingly, the microlenses Z1 can be equal in size and shape for the green pixels Gr and Gb, the red pixel R, and the blue pixel B. In addition, it is possible to reduce uneven sensitivity to the green pixels Gr and Gb, the red pixels R, and the blue pixels B caused by distortion of the microlenses Z1, thereby resulting in improvement of image quality.

Alternatively, as illustrated in FIG. 4B, one microlens Z2 each may be provided in common for the red pixel R and the blue pixel B.

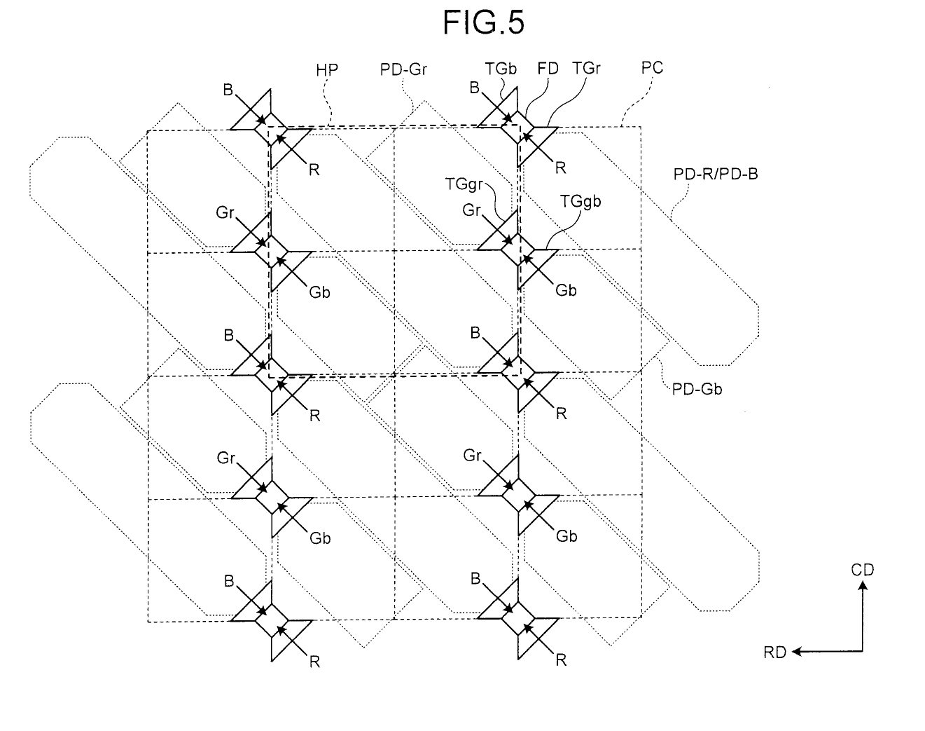

FIG. 5 is a plane view of a layout example of photodiodes PD, floating diffusions FD, and gate electrodes TG as photoelectric conversion layers in the solid-state imaging device according to the first embodiment.

Referring to FIG. 5, the red pixels R are provided with the red photoelectric conversion layers PD-R, the blue pixels B are provided with the blue photoelectric conversion layers PD-B, the green pixels Gr are provided with the green photoelectric conversion layers PD-Gr, and the green pixels Gb are provided with the green photoelectric conversion layers PD-Gb. The blue photoelectric conversion layers PD-B overlap the red photoelectric conversion layers PD-R. The red photoelectric conversion layers PD-R and the blue photoelectric conversion layers PD-B are arranged obliquely at the longer sides with respect to the column direction CD. The green photoelectric conversion layers PD-Gr and PD-Gb are arranged along the shorter sides of the red photoelectric conversion layers PD-R and the blue photoelectric conversion layers PD-B. The green photoelectric conversion layers PD-Gr and PD-Gb may be opposed to each other between the red photoelectric conversion layers PD-R and the blue photoelectric conversion layers PD-B.

Each of the Bayer arrays HP is provided with gate electrodes TGr, TGb, TGgr, and TGgb and first to fourth floating diffusions FD. The floating diffusions FD are arranged at both ends of the red photoelectric conversion layer PD-R and the blue photoelectric conversion layer PD-B along the longer sides and between the green photoelectric conversion layers PD-Gr and PD-Gb. In addition, in each of the Bayer arrays HP, charge in the blue photoelectric conversion layer PD-B is transferred to the first floating diffusion FD via the gate electrode TGb, charge in the red photoelectric conversion layer PD-R is transferred to the second floating diffusion FD via the gate electrode TGr, charge in the green photoelectric conversion layer PD-Gr is transferred to the third floating diffusion FD via the gate electrode TGgr, and charge in the green photoelectric conversion layer PD-Gb is transferred to the fourth floating diffusion FD via the gate electrode TGgb. The first floating diffusion FD in a first Bayer array HP is shared by the blue photoelectric conversion layer PD-Bin the first Bayer array HP and the red photoelectric conversion layer PD-R in a second Bayer array HP obliquely adjacent to the first Bayer array HP. The second floating diffusion FD in the first Bayer array HP is shared by the red photoelectric conversion layer PD-R in the first Bayer array HP and the blue photoelectric conversion layer PD-B in the third Bayer array HP obliquely adjacent to the first Bayer array HP. The third floating diffusion in the first Bayer array HP is shared by the green photoelectric conversion layer PD-Gr in the first Bayer array HP and the green photoelectric conversion layer PD-Gb in the fourth Bayer array HP adjacent to the first Bayer array HP in the row direction RD. The fourth floating diffusion FD in the first Bayer array HP is shared by the green photoelectric conversion layer PD-Gb in the first Bayer array HP and the green photoelectric conversion layer PD-Gr in the fifth Bayer array HP adjacent to the first Bayer array HP in the row direction RD.

To configure the Bayer array HP illustrated in FIG. 1 in a two-pixel one-cell form, it is necessary to connect the red pixel r and the blue pixel b to the shared floating diffusion FD. At that time, if the sides of the red pixel r, the blue pixel b, and the green pixels g are parallel to the column direction CD and the area of the green pixels g is made large, the connection part of the red pixel r and the blue pixel b becomes small. In contrast, by inclining the longer sides of the red photoelectric conversion layer PD-R, the blue photoelectric conversion layer PD-B, and the green photoelectric conversion layers PD-Gr and PD-Gb with respect to the column direction CD, it is possible to unify the widths of the red photoelectric conversion layer PD-R and the blue photoelectric conversion layer PD-B while assuring the areas of the green photoelectric conversion layers PD-Gr and PD-Gb, thereby realizing smooth charge transfer.

In addition, by unifying the widths of the red photoelectric conversion layer PD-R and the blue photoelectric conversion layer PD-B, it is possible to reduce the length of the boundary between the adjacent portions of the green photoelectric conversion layers PD-Gr and PD-Gb, thereby reducing color mixture.

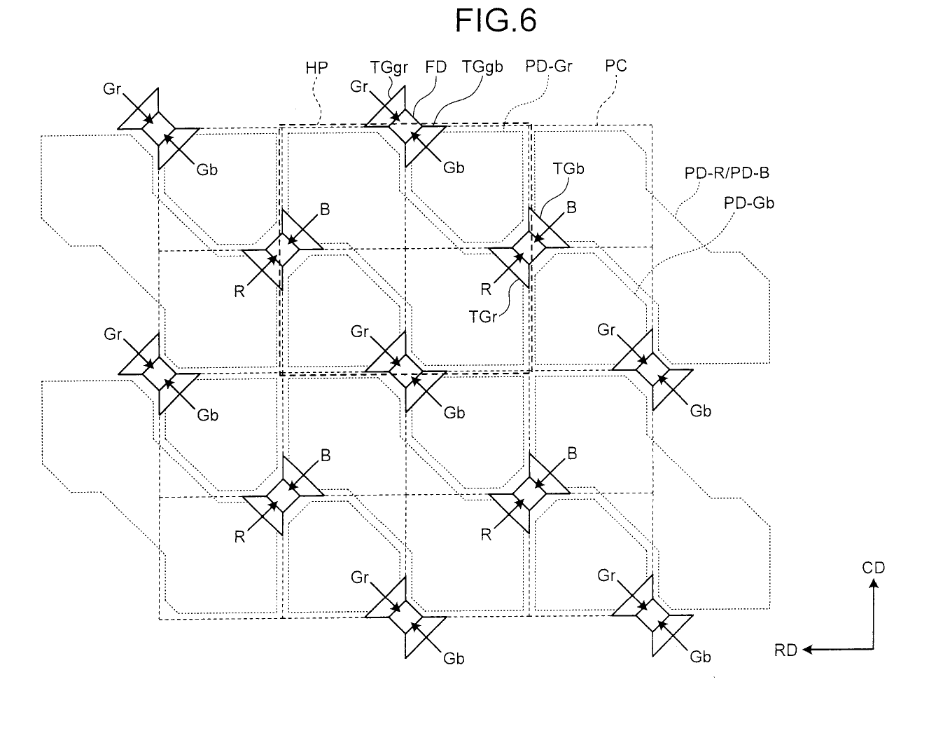

FIG. 6 is a plane view of another layout example of photodiodes, floating diffusions, and gate electrodes in the solid-state imaging device according to the first embodiment.

Referring to FIG. 6, the red photoelectric conversion layers PD-R and the blue photoelectric conversion layers PD-B are configured so as to be narrower at intermediate portions than at the both end portions of the longer sides so that the green photoelectric conversion layers PD-Gr and PD-Gb are fitted into the intermediate portions. In addition, the floating diffusions FD are arranged at side portions of the both ends of the longer sides of the red photoelectric conversion layers PD-R and the blue photoelectric conversion layers PD-B, and are also arranged between the green photoelectric conversion layers PD-Gr and PD-Gb. A first floating diffusion FD in the first Bayer array HP is shared by the blue photoelectric conversion layer PD-B in the first Bayer array HP and the red photoelectric conversion layer PD-R in a second Bayer array adjacent to the first Bayer array in the row direction RD. A second floating diffusion FD in the first Bayer array HP is shared by the red photoelectric conversion layer PD-R in the first Bayer array HP and the blue photoelectric conversion layer PD-B in a third Bayer array HP adjacent to the first Bayer array HP in the row direction RD. A third floating diffusion FD in the first Bayer array HP is shared by the green photoelectric conversion layer PD-Gr in the first Bayer array HP and the green photoelectric conversion layer PD-Gb in a fourth Bayer array HP adjacent to the first Bayer array HP in the column direction CD. A fourth floating diffusion FD in the first Bayer array HP is shared by the green photoelectric conversion layer PD-Gb in the first Bayer array HP and the green photoelectric conversion layer PD-Gr in a fifth Bayer array HP adjacent to the first Bayer array HP in the column direction CD.

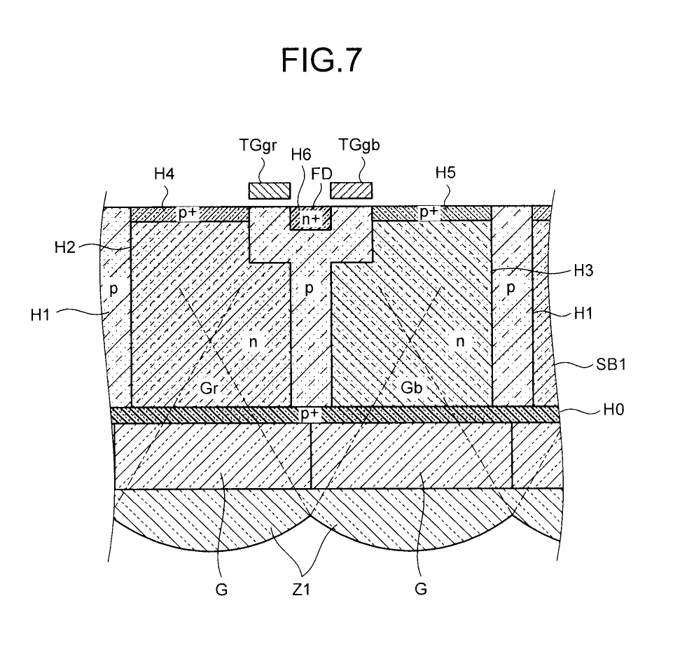

FIG. 7 is a schematic cross-sectional view of a configuration example of the solid-state imaging device taken along green filters illustrated in FIG. 3. FIG. 7 illustrates the configuration corresponding to FIGS. 4B and 5.

Referring to FIG. 7, an impurity diffusion layer H1 is formed on a semiconductor layer SB1, and an impurity diffusion layer H0 is formed on the back surface side of the impurity diffusion layer H1. In the green pixel Gr, an impurity diffusion layer H2 is formed on the semiconductor layer SB1, and an impurity diffusion layer H4 is formed on the front surface side of the impurity diffusion layer H2. In the green pixel Gb, an impurity diffusion layer H3 is formed on the semiconductor layer SB1, and an impurity diffusion layer H5 is formed on the front surface side of the impurity diffusion layer H3. In addition, an impurity diffusion layer H6 is formed on the front surface side of the semiconductor layer SB1 between the impurity diffusion layers H4 and H5, thereby forming a floating diffusion FD. The impurity diffusion layer H1 can be set to p-type. The impurity diffusion layers H2 and H3 can be set to n-type. The impurity diffusion layers H0, H4, and H5 can be set to p⁺-type. The impurity diffusion layer H6 can be set to n′-type.

On the semiconductor layer SB1, the gate electrode TGgr is arranged on the impurity diffusion layer H1 between the impurity diffusion layers H4 and H6, and the gate electrode TGgb is arranged on the impurity diffusion layer H1 between the impurity diffusion layers H5 and H6. Green filters G are formed on the back surface side of the semiconductor layer SB1 for each of the green pixels Gr and Gb. Microlenses Z1 are arranged on the green filter G for each of the green pixels Gr and Gb.

When light collected by the microlenses Z1 enters the green filters G, green light is extracted and entered into the green pixels Gr and Gb. Then, the green light is photoelectric-converted to generate charges in each of the pixel green pixels Gr and Gb, and the charges are accumulated in each of the green pixels Gr and Gb. Then, when a read voltage is applied to the gate electrodes TGgr and TGgb, the charges accumulated in the green pixels Gr and Gb are read out to the floating diffusion FD.

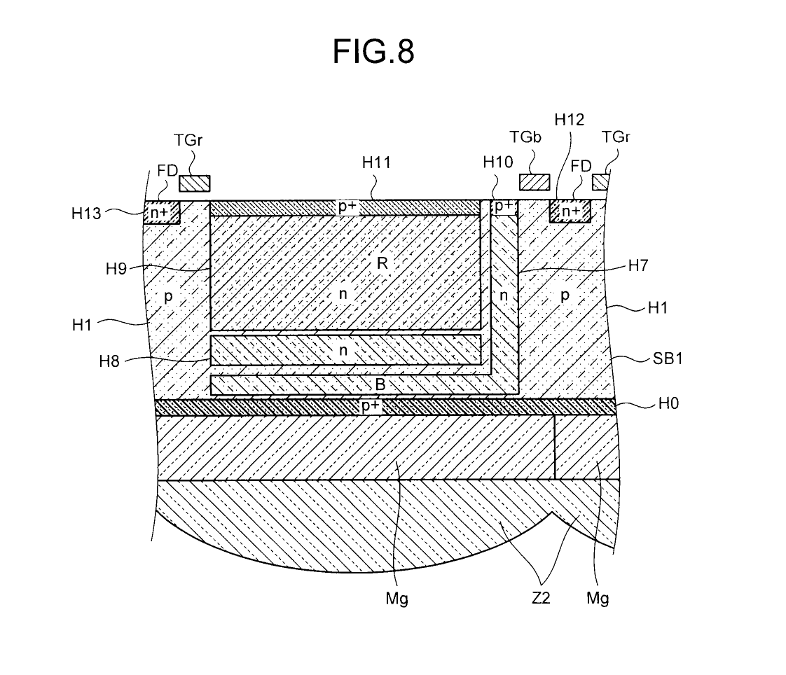

FIG. 8 is a schematic cross-sectional view of a configuration example of the solid-state imaging device taken along magenta filters illustrated in FIG. 3. FIG. 8 illustrates the configuration corresponding to FIGS. 4B and 5.

Referring to FIG. 8, the impurity diffusion layer H1 is formed on the semiconductor layer SB1, and the impurity diffusion layer H0 is formed on the back surface side of the impurity diffusion layer H1. In the blue pixel B, an impurity diffusion layer H7 is formed on the semiconductor layer SB1. In the red pixel R, an impurity diffusion layer H9 is formed on the semiconductor layer SB1, and an impurity diffusion layer H11 is formed on the front surface side of the impurity diffusion layer H9. The impurity diffusion layer H7 is located under the impurity diffusion layer H9 and extended to the front surface side of the semiconductor layer SB1 along one side of the impurity diffusion layer H9. In addition, an impurity diffusion layer H10 is formed on the extension portion of the impurity diffusion layer H9. An impurity diffusion layer H8 is arranged between the impurity diffusion layers H7 and H9. At the front surface side of the semiconductor layer SB1, impurity diffusion layers H12 and H13 are formed on both sides of the impurity diffusion layers H10 and H11, thereby forming floating diffusions FD. The impurity diffusion layers H7, H8, and H9 can be set to n-type. The Impurity diffusion layers H10 and H11 can be set to p⁺-type. The impurity diffusion layers H12 and H13 can be set to type.

In addition, on the semiconductor layer SB1, the gate electrode TGb is arranged on the impurity diffusion layer H1 between the impurity diffusion layers H10 and H12, and the gate electrode TGr is arranged on the impurity diffusion layer H1 between the impurity diffusion layers H11 and H13. The magenta filter Mg is formed on the back surface side of the semiconductor layer SB1 for common use by the blue pixel B and the red pixel R. The microlens Z2 is arranged on the magenta filter Mg for common use by the blue pixel B and the red pixel R.

When light collected by the microlens Z2 enters the magenta filters Mg, red light and blue light are extracted. The blue light enters the blue pixels B, and the red light enters the red pixels R. Then, when the blue light is photoelectric-converted in the blue pixels B, charges are generated and accumulated in the blue pixels B. Then, when a reading voltage is applied to the gate electrode TGb, the charges accumulated in the blue pixels B are read out to the floating diffusion FD. In addition, when the red light is photoelectric-converted in the red pixels R, charges are generated and accumulated in the red pixels R. Then, when a reading voltage is applied to the gate electrode TGr, the charges accumulated in the red pixels R are read out to the floating diffusion FD.

By arranging the impurity diffusion layer H8 between the impurity diffusion layers H7 and H9, it is possible to improve color separation properties of the red light and blue light.

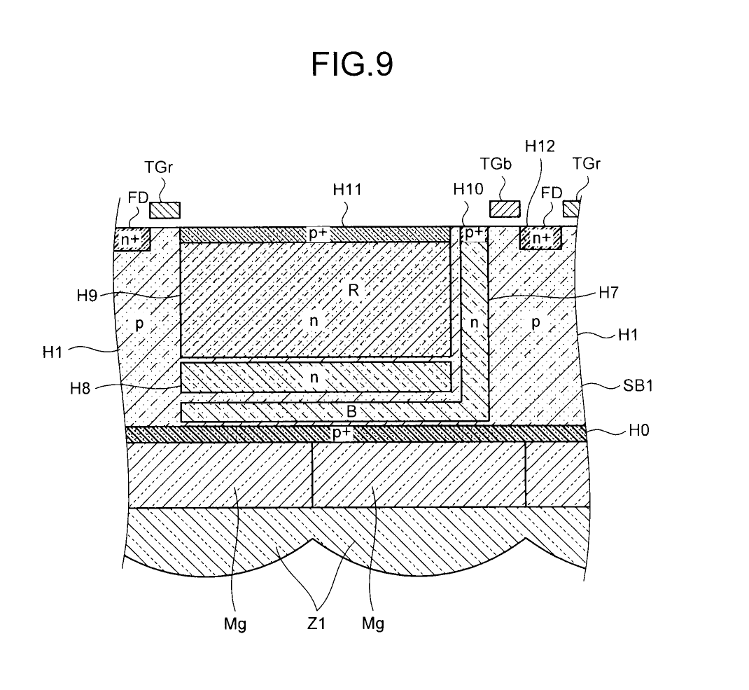

FIG. 9 is a schematic cross-sectional view of another configuration example of the solid-state imaging device taken along magenta filters illustrated in FIG. 3. FIG. 9 illustrates the configuration corresponding to FIGS. 4A and 5.

The configuration of FIG. 9 is the same as the configuration of FIG. 8, except that, instead of the microlenses Z2 illustrated in FIG. 8, the microlenses Z1 are arranged for common use by the blue pixel B and the red pixel R.

### Second Embodiment

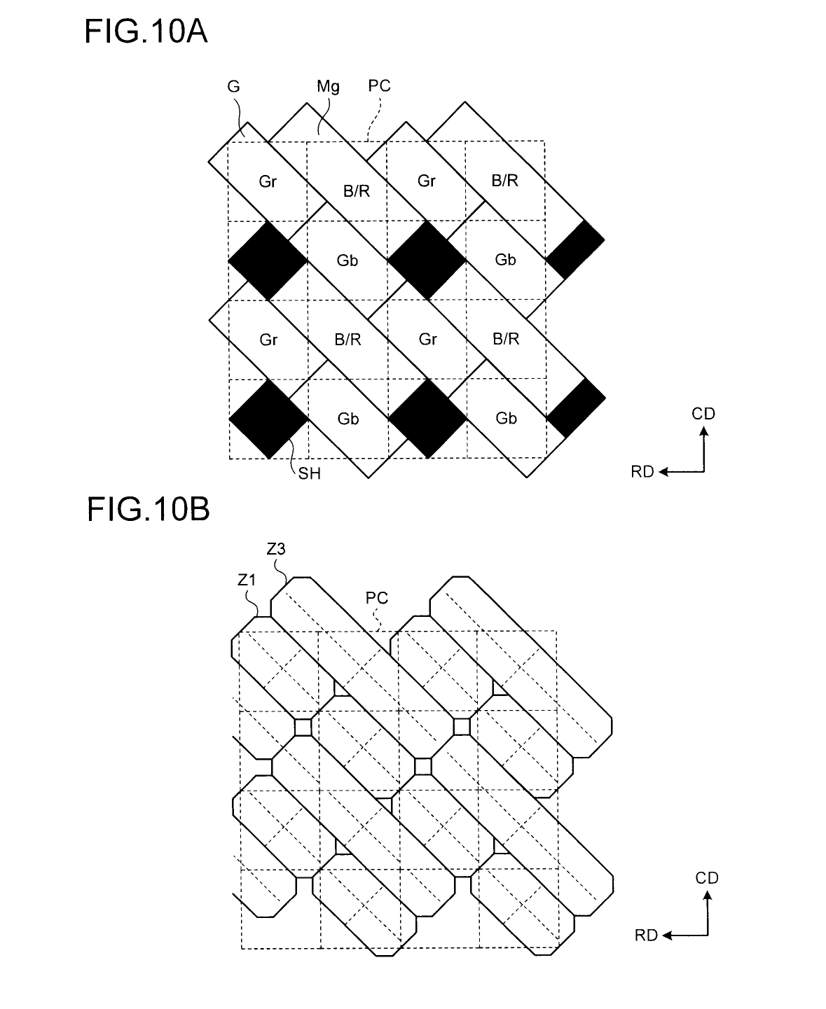

FIG. 10A is a plane view of a layout example of color filters in a solid-state imaging device according to a second embodiment, and FIG. 10B is a plane view of a layout example of microlenses in the solid-state imaging device according to the second embodiment.

Referring to FIG. 10A, at the solid-state imaging device, light-shielding films SH are added to the configuration of FIG. 3. The material for the light-shielding films SH may be a resin containing carbon or the like, or may be a metal such as Al or tungsten. The light-shielding films SH can be arranged to cover the extension portions of the blue pixels B under the red pixels R, which are extended to the front surface side. Accordingly, it is possible to suppress entry of red light into the blue pixels B in a back surface-irradiation CMOS sensor, thereby reducing color mixture.

Referring to FIG. 10B, microlenses Z3 are arranged on the magenta filters Mg and the light-shielding films SH for common use by the blue pixels B and the red pixels R. The longitudinal both sides of the microlens Z3 are located on the light-shielding films SH. Accordingly, it is possible to efficiently enter the blue light and the red light into the blue pixels B and the red pixels R, respectively.

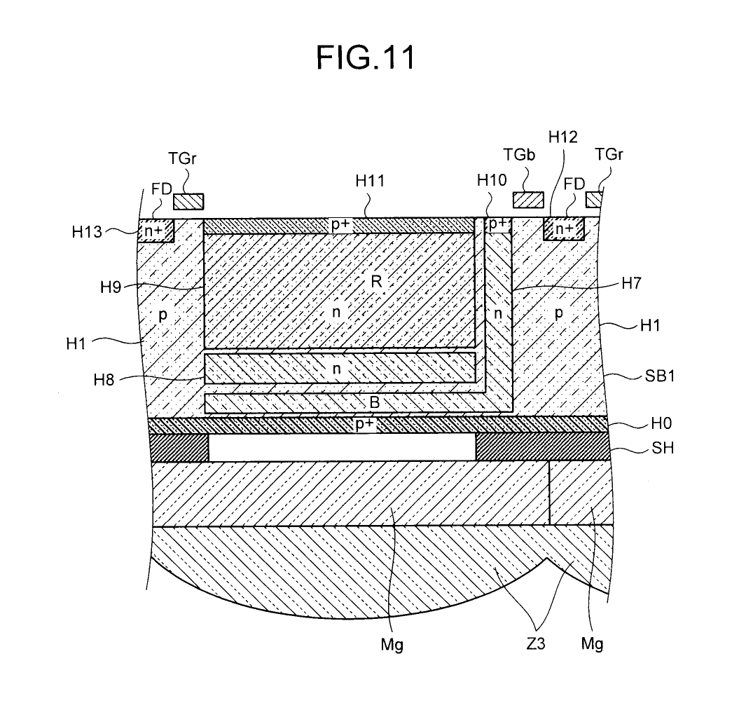

FIG. 11 is a schematic cross-sectional view of a configuration example of the solid-state imaging device taken along magenta filters illustrated in FIG. 10A.

Referring to FIG. 11, at the solid-state imaging device, the light-shielding films SH are added to the configuration of FIG. 8. The light-shielding films SH can be arranged between the magenta filters Mg and the semiconductor layer SB1. In addition, the light-shielding films SH can be arranged to cover the extension portions of the impurity diffusion layer H7 and the impurity diffusion layers H12 and H13.

### Third Embodiment

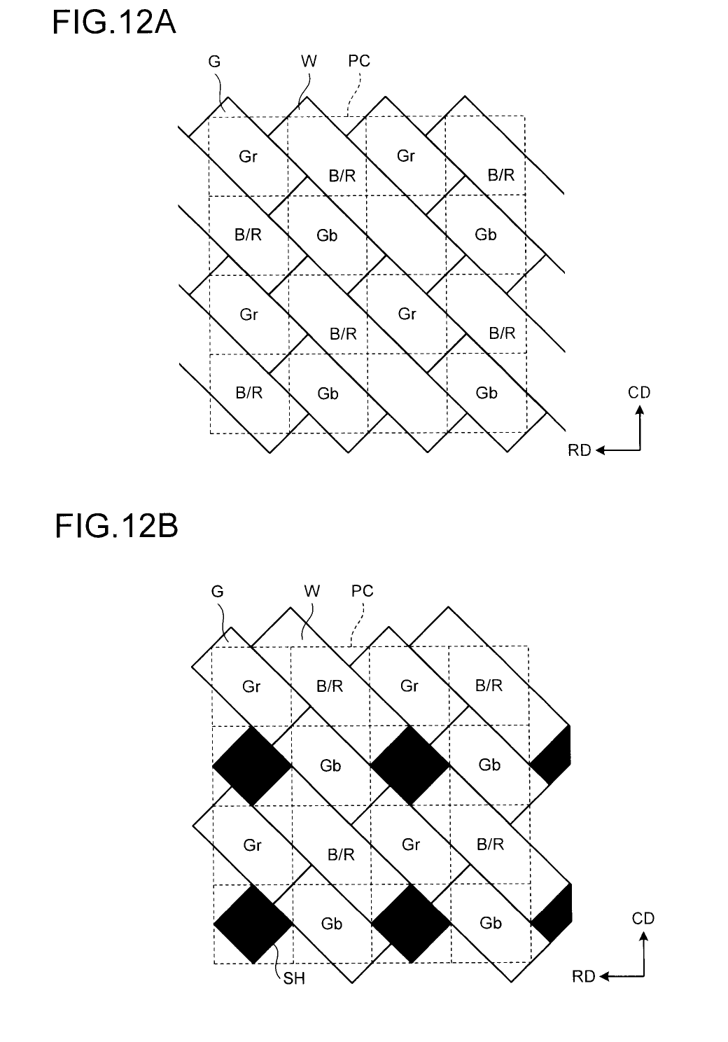

FIG. 12A is a plane view of a layout example of color filters in a solid-state imaging device according to a third embodiment, and FIG. 12B is a plane view of another layout example of color filters in the solid-state imaging device according to the third embodiment.

Referring to FIG. 12A, at the solid-state imaging device, instead of the magenta filters Mg illustrated in FIG. 3, white filters W are arranged on the red pixels R and the blue pixels B. This makes it possible to reduce light loss by the magenta filters Mg and achieve high sensitivity.

Referring to FIG. 12B, at the solid-state imaging device, the light-shielding films SH are added to the configuration of FIG. 12A. The light-shielding films SH of FIG. 12B can be arranged in the same manner as the light-shielding films SH of FIG. 10A.

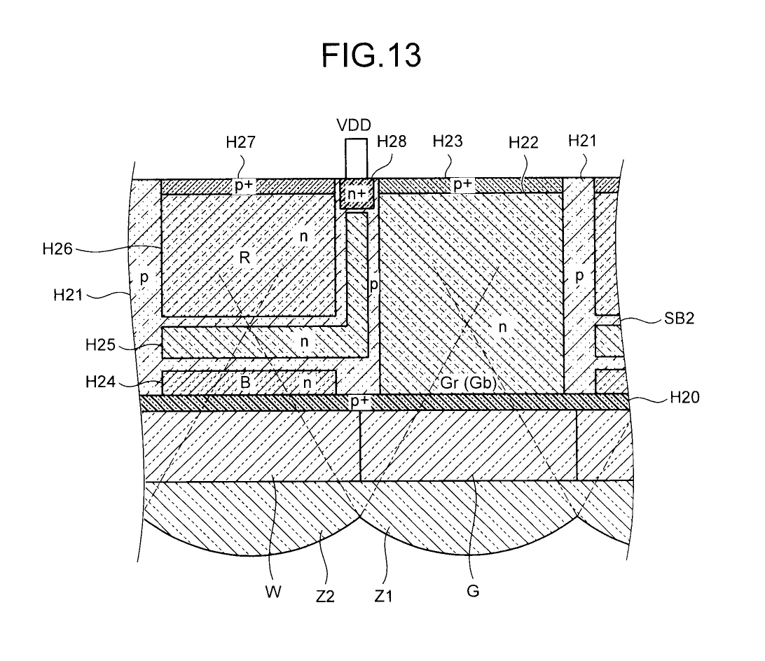

FIG. 13 is a schematic cross-sectional view of another configuration example of the solid-state imaging device taken along a white filter and a green filter illustrated in FIG. 12A.

Referring to FIG. 13, an impurity diffusion layer H21 is formed on a semiconductor layer SB2, and an impurity diffusion layer H20 is formed on the back surface side of the impurity diffusion layer H21. In the green pixel Gr (Gb), an impurity diffusion layer H22 is formed on the semiconductor layer SB2, and an impurity diffusion layer H23 is formed on the front surface side of the impurity diffusion layer H22. In the blue pixel B, an impurity diffusion layer H24 is formed on the semiconductor layer SB2. In the red pixel R, an impurity diffusion layer H26 is formed on the semiconductor layer SB2, and an impurity diffusion layer H27 is formed on the front surface side of the impurity diffusion layer H26. The impurity diffusion layer H24 is located under the impurity diffusion layer H26. An impurity diffusion layer H25 is arranged between the impurity diffusion layers H24 and H26. The impurity diffusion layer H25 is extended to the front surface side of the semiconductor layer SB2 along one side of the Impurity diffusion layer H26. In addition, an impurity diffusion layer H28 is formed on the extension portion of the impurity diffusion layer H25. The impurity diffusion layer H28 is connected to the power source potential VDD. The impurity diffusion layer H21 can be set to p-type. The impurity diffusion layers H22, H24, H25, and H26 can be set to n-type. The impurity diffusion layers H20, H23, and H27 can be set to p⁺-type. The impurity diffusion layer H28 can be set to n⁺-type.

In addition, on the back surface side of the semiconductor layer SB2, the green filter G is formed for the green pixel Gr (Gb), and a white filter W is formed for common use by the blue pixels B and the red pixels R. The microlens Z1 is arranged on the green filter G. The microlens Z2 is arranged on the white filter W.

When light collected by the microlens Z1 enters the green filters G, green light is extracted and entered to the green pixel Gr (Gb). Then, when the green light is photoelectric-converted in the green pixel Gr (Gb), charges are generated and accumulated in the green pixel Gr (Gb).

In addition, light collected by the microlens Z2 passes through the white filter W. Then the blue light enters the blue pixel B, and the red light enters the red pixel R. When the blue light is photoelectric-converted in the blue pixel B, charges are generated and accumulated in the blue pixel B. When the red light is photoelectric-converted in the red pixel R, charges are generated and accumulated in the red pixel R. In addition, the green light having passed through the white filter W enters the impurity diffusion layer H25. Then, when the green light is photoelectric-converted in the impurity diffusion layer H25, charges are generated and discharged to the power source potential VDD. The power source potential VDD may be a DC potential or may be pulse-driven.

By discharging the charges generated in the impurity diffusion layer H25 to the power source potential VDD, it is possible to reduce color mixture also in the case of using the white filter W for the blue pixel B and the red pixel R.

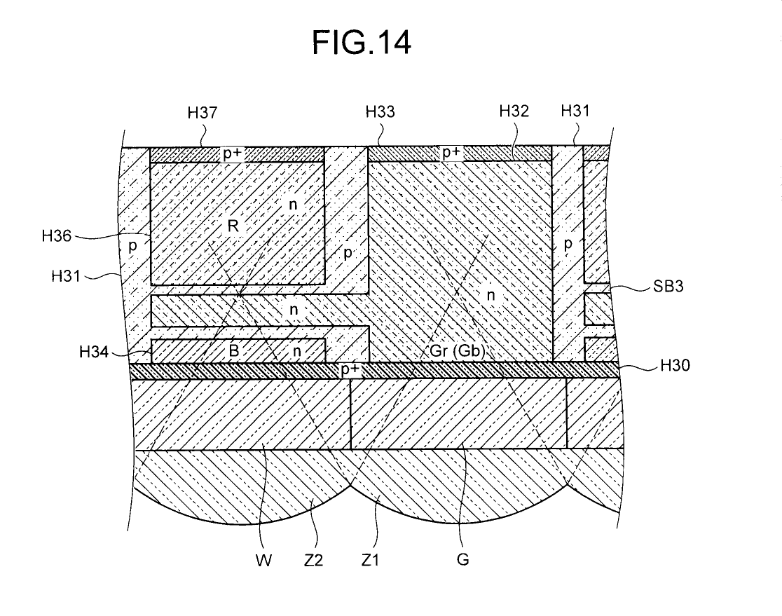

FIG. 14 is a schematic cross-sectional view of another configuration example of the solid-state imaging device taken along a white filter and a green filter illustrated in FIG. 12A.

Referring to FIG. 14, an impurity diffusion layer H31 is formed on a semiconductor layer SB3, and an impurity diffusion layer H30 is formed on the back surface side of the impurity diffusion layer H31. In the green pixel Gr (Gb), an impurity diffusion layer H32 is formed on the semiconductor layer SB3, and an impurity diffusion layer H33 is formed on the front surface side of the impurity diffusion layer H32. In the blue pixel B, an impurity diffusion layer H34 is formed on the semiconductor layer SB3. In the red pixel R, an impurity diffusion layer H36 is formed on the semiconductor layer SB3, and an impurity diffusion layer H37 is formed on the front surface side of the impurity diffusion layer H36. The impurity diffusion layer H34 is located under the impurity diffusion layer H36. An impurity diffusion layer H32 is laterally extended and arranged between the impurity diffusion layers H34 and H36. The impurity diffusion layer H31 can be set to p-type. The impurity diffusion layers H32, H34, and H36 can be set to n-type. The impurity diffusion layers H30, H33, and H37 can be set to p⁺-type.

In addition, on the back surface side of the semiconductor layer SB3, the green filter G is formed for each of the green pixels Gr (Gb), and the white filter W is formed for common use by the blue pixel B and the red pixel R. The microlens Z1 is arranged on the green filter G. The microlens Z2 is arranged on the white filter W.

When light collected by the microlens Z1 enters the green filter G, green light is extracted and entered to the green pixel Gr (Gb). Then, when the green light is photoelectric-converted in the green pixel Gr (Gb), charges are generated and accumulated in the green pixel Gr (Gb).

In addition, light collected by the microlens Z2 passes through the white filter W. Then the blue light enters the blue pixel B, and the red light enters the red pixel R. When the blue light is photoelectric-converted in the blue pixel B, charges are generated and accumulated in the blue pixel B. When the red light is photoelectric-converted in the red pixel R, charges are generated and accumulated in the red pixel R. In addition, the green light having passed through the white filter W enters the extension portion of the impurity diffusion layer H32. Then, when the green light is photoelectric-converted in the extension portion of the impurity diffusion layer H32, charges are generated and accumulated in the green pixel Gr (Gb). By accumulating in the green pixel Gr (Gb) the charges generated in the extension portion of the impurity diffusion layer H32, it is possible to improve color separation properties and enhance sensitivity to the green light.

### Fourth Embodiment

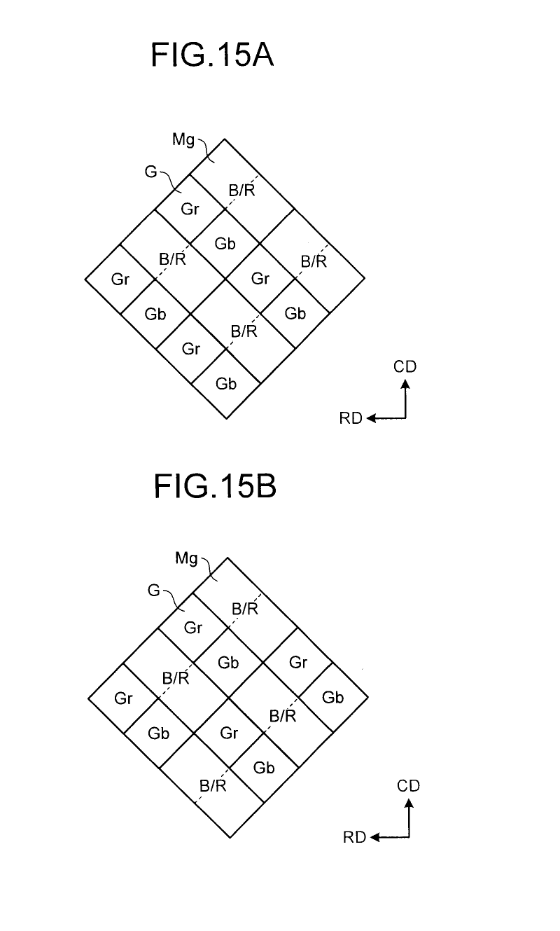

FIG. 15A is a plane view of a layout example of color filters in a solid-state imaging device according to a fourth embodiment.

In the configuration of FIG. 3, the color filters are arranged obliquely with respect to the pixels PC squarely arranged, boundaries between the green pixels Gr and Gb are shifted from boundaries between the red pixels R and the blue pixels B. Meanwhile, in the configuration of FIG. 15A, since the pixels PC squarely arranged are rotated 45 degrees, boundaries between the green pixels Gr and Gb agrees with boundaries between the red pixels R and the blue pixels B. According to this configuration, the color filters have an easy-to-form shape of a square inclined 45 degrees from the rectangular color filters illustrated in FIG. 3. In the configuration of FIG. 15A, resolution in the leftward oblique direction becomes ½ of resolution in the rightward oblique direction. However, in the configuration of FIG. 15A, interpolation signal processing for conversion into an array of squarely-arranged pixels can be performed to provide signals for green light with a √2-fold improvement in resolution in each of the horizontal direction and the vertical direction. This makes it possible to yield a two-fold improvement in effectiveness as compared to a Bayer array of squarely-arranged pixels with the same number of green pixels.

### Fifth Embodiment

FIG. 15B is a plane view of a layout example of microlenses in a solid-state imaging device according to a fifth embodiment.

Referring to FIG. 15B, obliquely arranged are sets of two pixels of the green pixels Gr and Gb, and B/R two-layered pixels having the area of two pixels in which the blue photoelectric conversion layer and the red photoelectric conversion layer overlapping the blue photoelectric conversion layer in a depth direction. In addition, the sets of two pixels of the green pixels Gr and Gb and the B/R two-layered pixels having the area of two pixels are arranged in a mesh form. In this configuration, resolution in the leftward oblique direction and resolution in the rightward oblique direction can be equalized. In addition, in this configuration, interpolation signal processing for conversion into an array of squarely-arranged pixels can be performed to provide signals for green light with a √2-fold improvement in resolution in each of the horizontal direction and the vertical direction. This makes it possible to yield a two-fold improvement in effectiveness as compared to a Bayer array of squarely-arranged pixels with the same number of green pixels.

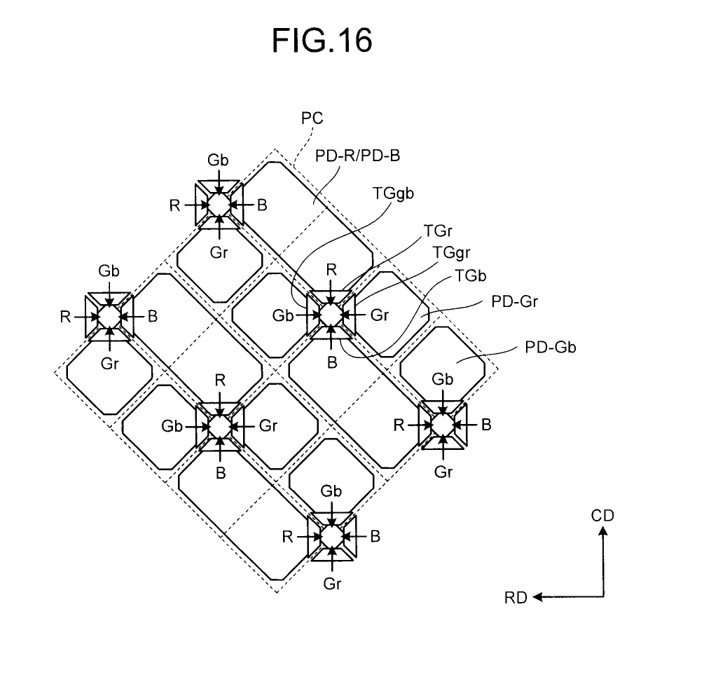

FIG. 16 is a plane view of a layout example of photodiodes, floating diffusions, and gate electrodes corresponding to the layout of color filters illustrated in FIG. 15B.

Referring to FIG. 16, in this configuration, the pixels PC are inclined at 45 degrees with respect to the configuration of FIG. 5. In addition, the green photoelectric conversion layers PD-Gr and PD-Gb are accommodated in one pixel PC each, and the red photoelectric conversion layers PD-R and the blue photoelectric conversion layers PD-B are accommodated in two pixels PC each. The blue photoelectric conversion layers PD-B overlap the red photoelectric conversion layers PD-R. Pixel signals read from the pixels PC can be transmitted in the column direction CD via the vertical signal wires Vlin.

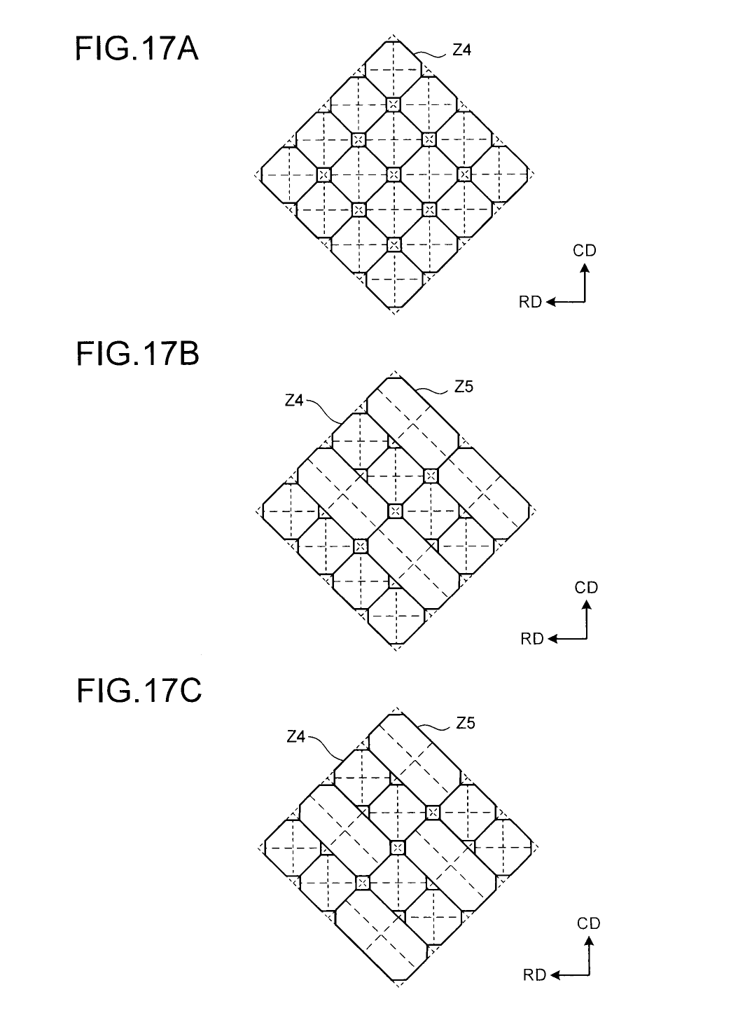

FIG. 17A is a plane view of a layout example of microlenses corresponding to the color filter array illustrated in FIG. 15A or 15B, FIG. 17B is a plane view of another layout example of microlenses corresponding to the color filter array illustrated in FIG. 15A, and FIG. 17C is a plane view of another layout example of microlenses corresponding to the color filter array illustrated in FIG. 15B.

Referring to FIG. 17A, in this layout, microlenses Z4 of one-pixel size are provided. The layout of the microlenses Z4 can be used in the configuration of FIG. 15A or 15B. In this configuration, the microlenses Z4 can be equalized in size and shape for the green pixels Gr and Gb, the red pixels R, and the blue pixels B, thereby to suppress deterioration in image quality resulting from distortions in the microlenses Z4.

Referring to FIGS. 17B and 17C, in this layout, microlenses Z4 of one-pixel size and microlenses Z5 of two-pixel size are provided. The layout of the microlenses Z4 and Z5 illustrated in FIG. 17B can be used in the configuration of FIG. 15A. The layout of the microlenses Z4 and Z5 illustrated in FIG. 17C can be used in the configuration of FIG. 15B.

In the configurations of FIGS. 3 and 4, the color filters and microlenses for one pixel are rectangular in shape. Meanwhile, the color filter and microlenses for one pixel illustrated in FIGS. 15A, 15B, and FIGS. 17A to 17C can be formed in an easy-to-form shape of a square inclined at 45 degrees. This makes it possible to facilitate application to finer pixels and further reduce manufacturing variation.

### Sixth Embodiment

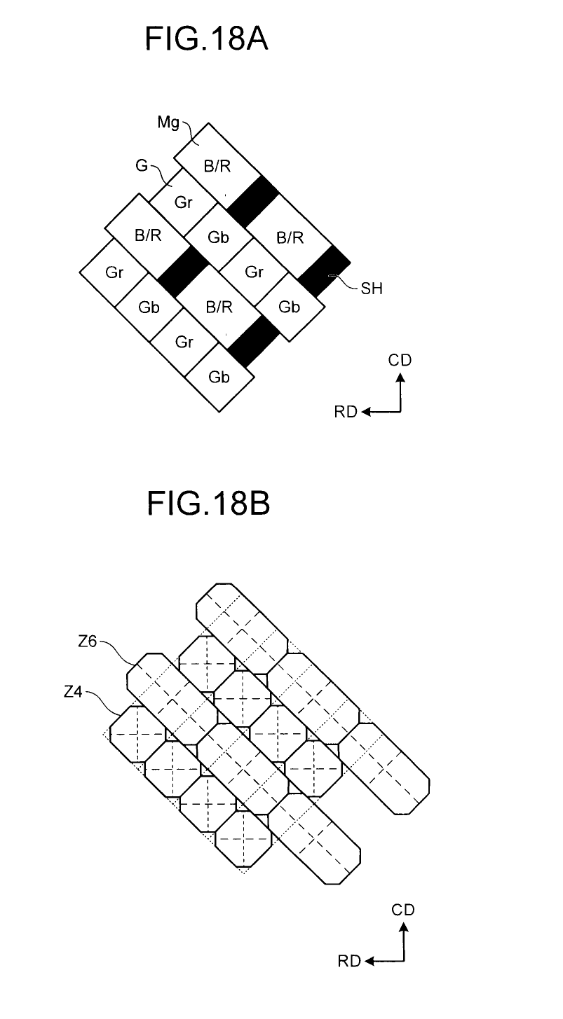

FIG. 18A is a plane view of a layout example of color filters in a solid-state imaging device according to a sixth embodiment, and FIG. 18B is a plane view of a layout example of microlenses in the solid-state imaging device according to the sixth embodiment.

Referring to FIG. 18A, at the solid-state imaging device, the light-shielding films SH are added to the configuration of FIG. 15A. The light-shielding films SH can be arranged so as to cover the extension portions of the blue pixels B under the red pixels R, which are extended to the front surface side.

Referring to FIG. 18B, microlenses Z6 are arranged on the magenta filters Mg and the light-shielding films SH for common use by the blue pixels B and the red pixels R. Both longitudinal ends of the microlenses Z6 are arranged on the light-shielding films SH.

### Seventh Embodiment

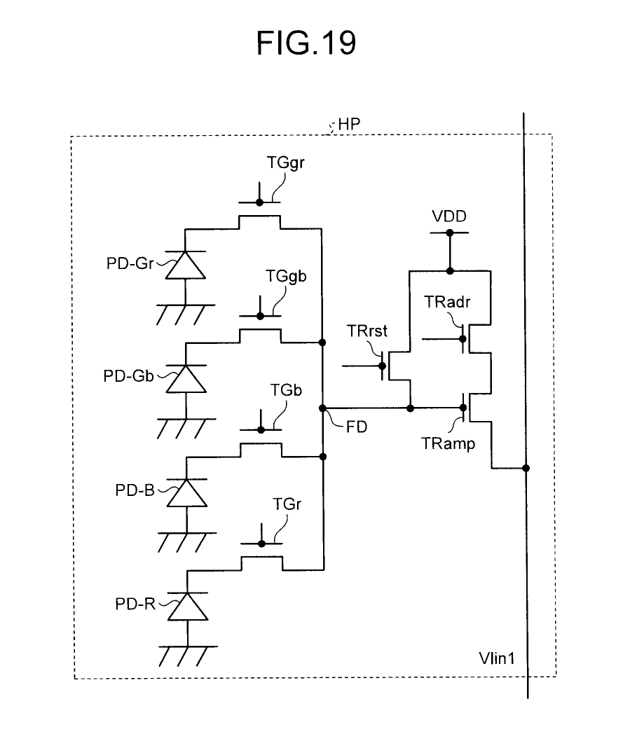

FIG. 19 is a circuit diagram illustrating a four-pixel one-cell configuration example of a Bayer array in a solid-state imaging device according to a seventh embodiment.

Referring to FIG. 19, provided in the Bayer array HP are the photo diodes PD-B, PD-R, PD-Gr, and PD-Gb, the row selection transistor TRadr, the amplification transistor TRamp, the reset transistor TRrst, and the read transistor TGb, TGr, TGgr, and TGgb. In addition, the floating diffusion FD is formed as a detection node at a connection point of the amplification transistor TRamp, the reset transistor TRrst, and the read transistors TGb, TGr, TGgr, and TGgb. The floating diffusion FD, the row selection transistor TRadr, the amplification transistor TRamp, and the reset transistor TRrst are shared by the photodiodes PD-B, PD-R, PD-Gr, and PD-Gb.

A source of the read transistor TGgr is connected to the photodiode PD-Gr, a source of the read transistor TGb is connected to the photodiode PD-B, a source of the read transistor TGr is connected to the photodiode PD-R, and a source of the read transistor TGgb is connected to the photodiode PD-Gb. In addition, a source of the reset transistor TRrst is connected to drains of the read transistors TGb, TGr, TGgr, and TGgb, and drains of the reset transistor TRrst and the row selection transistor TRadr are connected to the power source potential VDD. In addition, a source of the amplification transistor TRamp is connected to the vertical signal line Vlin1, a gate of the amplification transistor TRamp is connected to the drains of the read transistors TGb, TGr, TGgr, and TGgb, and a drain of the amplification transistor TRamp is connected to a source of the row selection transistor TRadr.

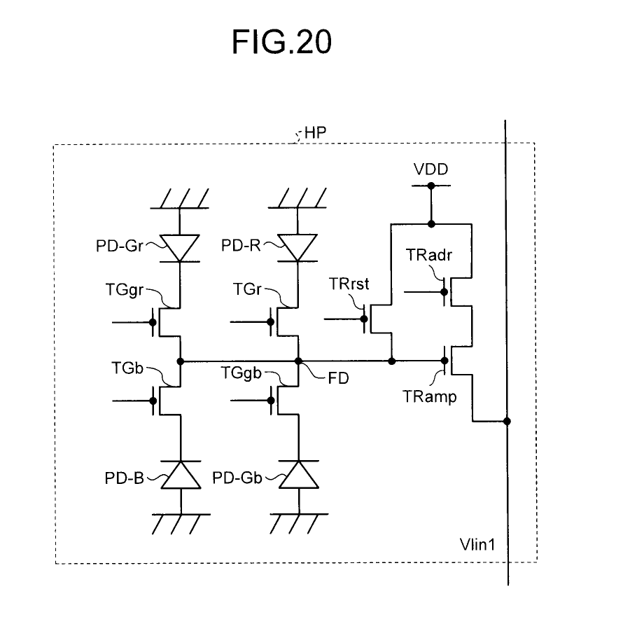

FIG. 20 is a circuit diagram illustrating another four-pixel one-cell configuration example of a Bayer array in the solid-state imaging device according to the seventh embodiment.

In the configuration of FIG. 19, the photodiodes PD-B, PD-R, PD-Gr, and PD-Gb are aligned in the column direction CD. Meanwhile, in the configuration of FIG. 20, the photodiodes PD-B, PD-R, PD-Gr, and PD-Gb are aligned in two rows and two columns in the column direction CD and the row direction RD.

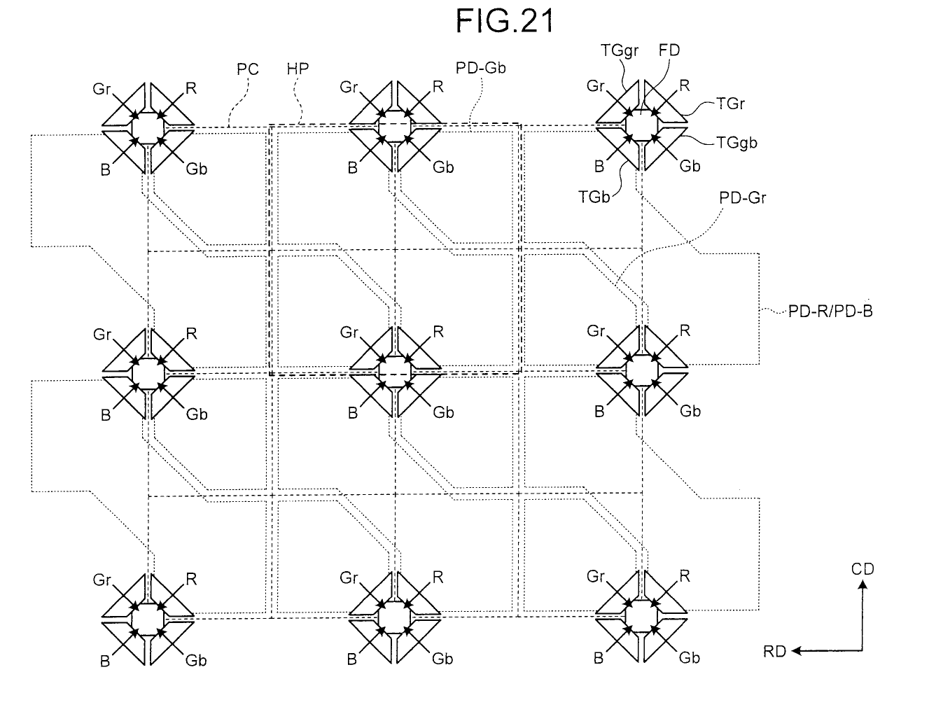

FIG. 21 is a plane view of a layout example of photodiodes, floating diffusions, and gate electrodes in the solid-state imaging device according to the seventh embodiment. The configuration of FIG. 21 corresponds to the circuit illustrated in FIG. 20.

Referring to FIG. 21, the red photoelectric conversion layers PD-R, the blue photoelectric conversion layers PD-B, and the green photoelectric conversion layers PD-Gr and PD-Gb are arranged in the same manner as in the configuration of FIG. 6. However, in the configuration of FIG. 6, four floating diffusions are provided in one Bayer array HP, whereas in the configuration of FIG. 21, two floating diffusions FD are provided in one Bayer array HP. The first floating diffusion FD in the first Bayer array HP is shared by the blue photoelectric conversion layer PD-B and the green photoelectric conversion layer PD-Gb in the first Bayer array HP and the red photoelectric conversion layer PD-R and the green photoelectric conversion layer PD-Gr in the second Bayer array HP adjacent to the first Bayer array HP in the column direction CD. The second floating diffusion FD in the first Bayer array HP is shared by the red photoelectric conversion layer PD-R and the green photoelectric conversion layer PD-Gr in the first Bayer array HP and the blue photoelectric conversion layer PD-B and the green photoelectric conversion layer PD-Gb in the third Bayer array HP adjacent to the first Bayer array HP in the column direction CD.

By using the four-pixel one-cell configuration, it is possible to decrease by half the numbers of the floating diffusions FD, the row selection transistors TRadr, and the amplification transistors TRamp and the reset transistors TRrst, as compared to those in the two-pixel one-cell configuration of FIG. 6. This makes it possible to increase the areas of the red photoelectric conversion layers PD-R, the blue photoelectric conversion layers PD-B, and the green photoelectric conversion layers PD-Gr and PD-Gb, thereby resulting in improvement of sensitivity and saturated signal amount.

### Eighth Embodiment

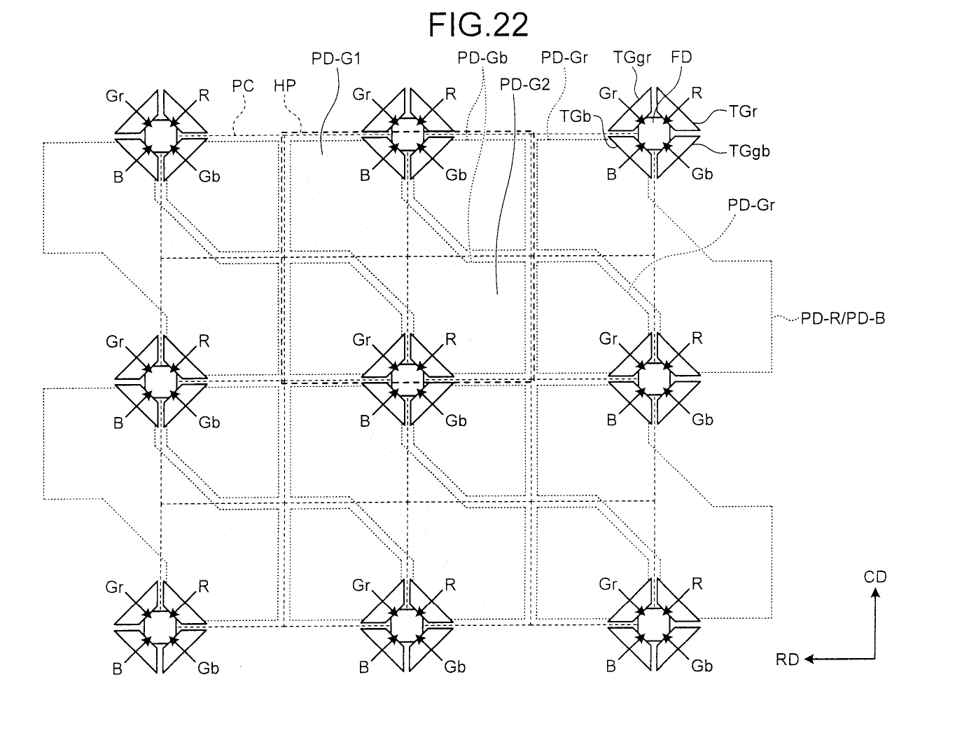

FIG. 22 is a plane view of a layout example of photodiodes, floating diffusions, and gate electrodes in a solid-state imaging device according to an eighth embodiment.

Referring to FIG. 22, in this configuration, extension portions of PD-G1 and PD-G2 are provided to the green photoelectric conversion layers PD-Gr and PD-Gb, respectively. The extension portions PD-G1 and PD-G2 are extended in the column direction CD and are arranged between the red photoelectric conversion layer PD-R and the blue photoelectric conversion layer PD-B in the depth direction. The extension portions PD-G1 and PD-G2 can be configured in the same manner as the extension portions of the impurity diffusion layer H32 illustrated in FIG. 14.

### Ninth Embodiment

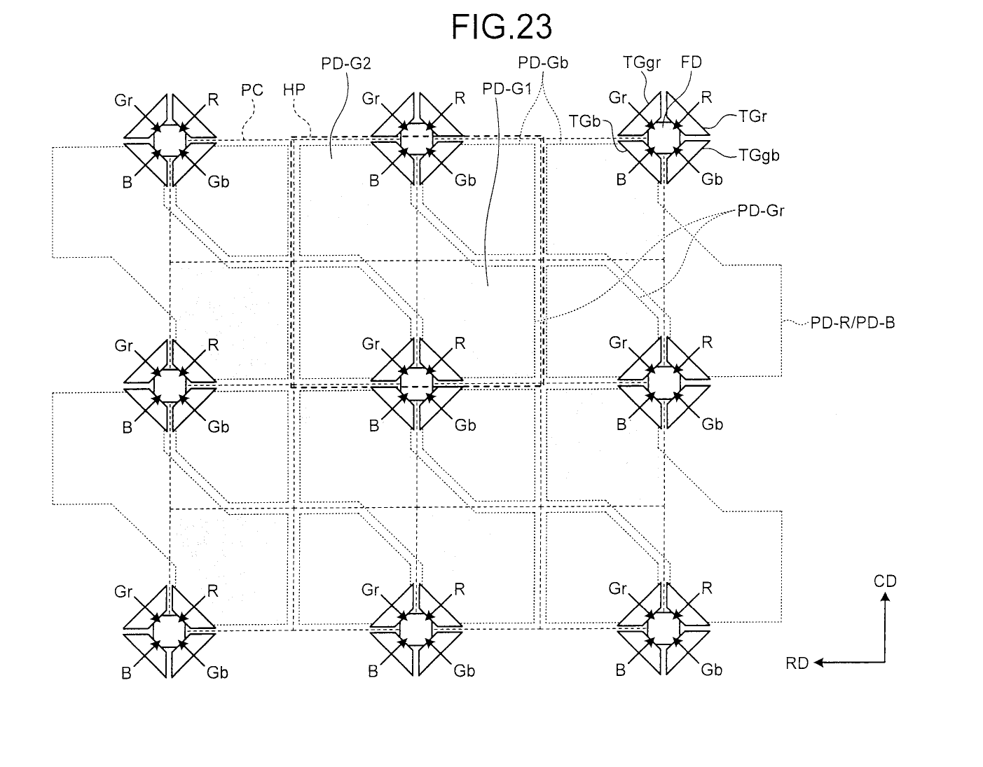

FIG. 23 is a plane view of a layout example of photodiodes, floating diffusions, and gate electrodes in a solid-state imaging device according to a ninth embodiment.

In the configuration of FIG. 22, the extension portions PD-G1 and PD-G2 are extended in the column direction CD. Meanwhile, in the configuration of FIG. 23, the extension portions PD-G1 and PD-G2 are extended in the row direction RD.

By providing the extension portions PD-G1 and PD-G2 to the green photoelectric conversion layers PD-Gr and PD-Gb, respectively, it is possible to improve sensitivity to green light.

### Tenth Embodiment

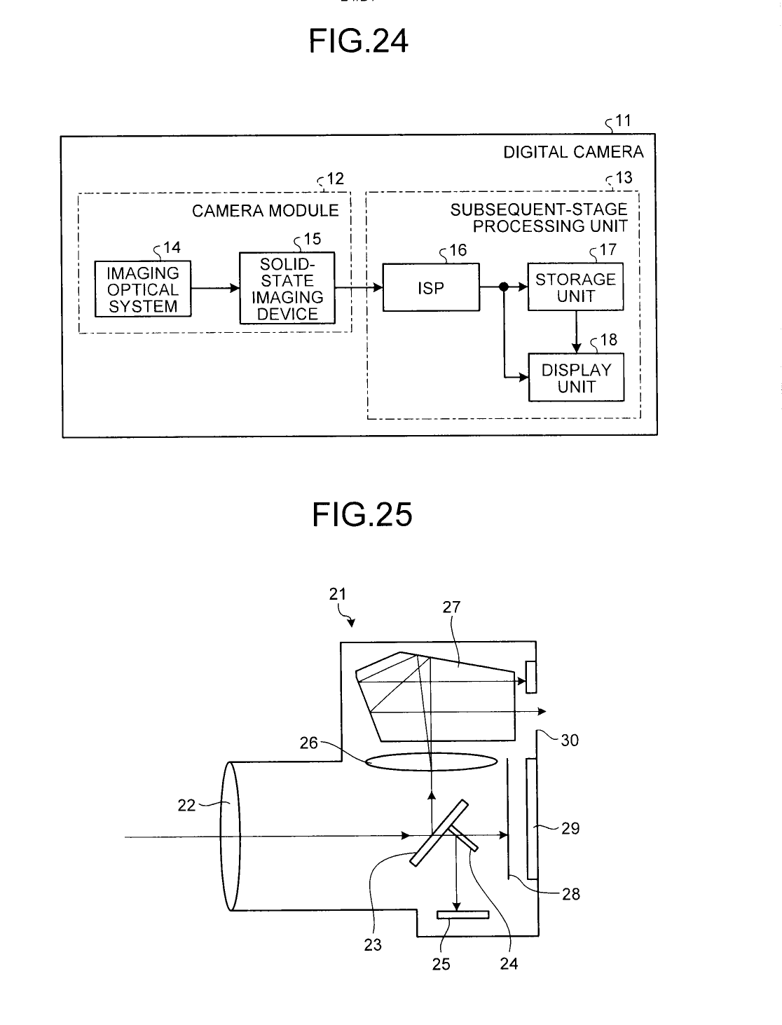

FIG. 24 is a schematic block diagram of a digital camera to which a solid-state imaging device according to a tenth embodiment is applied.

Referring to FIG. 24, a digital camera 11 has a camera module 12 and a subsequent-stage processing unit 13. The camera module 12 has an imaging optical system 14 and a solid-state imaging device 15. The subsequent-stage processing unit 13 has an image signal processor (ISP) 16, a storage unit 17, and a display unit 18. At least part of the ISP 16 may be configured to form one chip together with the solid-state imaging device 15.

The imaging optical system 14 captures light from a subject and forms an image of the subject. The solid-state imaging device 15 takes the image of the subject. The ISP 16 processes an image signal obtained from the imaging by the solid-state imaging device 15. The storage unit 11 stores the image having undergone the signal processing at the ISP 16. The storage unit 17 outputs the image signal to the display unit 18 according to the user's operation or the like. The display unit 18 displays the image according to the image signal input from the ISP 16 or the storage unit 17. The display unit 18 is a liquid crystal display, for example. The camera module 12 may be applied to not only the digital camera 11 but also electronic devices such as a camera-equipped mobile phone, for example.

### Eleventh Embodiment

FIG. 25 is a schematic cross-sectional view of a camera module to which a solid-state imaging device according to an eleventh embodiment is applied.

Referring to FIG. 25, light having entered from a subject into a lens 22 of the camera module 21 then enters a solid-state imaging device 29 through a main mirror 23, a sub mirror 24, and a mechanical shutter 28.

The light reflected on the sub mirror 24 enters an auto-focus (AF) sensor 25. At the camera module 21, focus adjustment is performed according to results of detection by the AF sensor 25. The light reflected on the main mirror 23 enters a finder 30 through a lens 26 and a prism 27.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device, comprising a pixel array unit in which pixels for accumulating photoelectric-converted charges are arranged in a matrix in a row direction and a column direction, wherein
the pixel array unit includes:
first and second two-pixel green photoelectric conversion layers that are arranged obliquely with respect to the column direction;
a blue photoelectric conversion layer having an area of two pixels that is arranged adjacent to the first and second green photoelectric conversion layers; and
a red photoelectric conversion layer that overlaps the blue photoelectric conversion layer in a depth direction.

2. The solid-state imaging device according to claim 1, comprising:
a green filter that is provided consecutively for two pixels on the first and second green photoelectric conversion layers; and
a filter different from the green filter that is provided consecutively for two pixels on the blue photoelectric conversion layer.

3. The solid-state imaging device according to claim 2, wherein
the filter different from the green filter is a magenta filter or a white filter, and
the green filter and the magenta filter or the white filter are alternately arranged for two pixels each.

4. The solid-state imaging device according to claim 1, wherein a pixel array of an output signal from the pixel array unit is output in a square arrangement.

5. The solid-state imaging device according to claim 1, wherein a pixel array of an output signal from the pixel array unit is output in an arrangement with an inclination of 45 degrees from the square arrangement.

6. The solid-state imaging device according to claim 1, wherein rectangular microlenses for collecting light are formed with an inclination of 45 degrees on the first green photoelectric conversion layer.

7. The solid-state imaging device according to claim 1, comprising vertical signal wires that transmit signals read from the pixels in the column direction.

8. The solid-state imaging device according to claim 1, wherein the first and second green photoelectric conversion layer are partially extended to between an overlapping portion between the blue photoelectric conversion layer and the red photoelectric conversion layer in the depth direction.

9. The solid-state imaging device according to claim 1, comprising a charge discharge layer between the overlapping portion between the blue photoelectric conversion layer and the red photoelectric conversion layer in the depth direction.

10. The solid-state imaging device according to claim 1, comprising:
a first floating diffusion that is shared by the first and second green photoelectric conversion layers adjacent to each other in an oblique direction with respect to the column direction; and
a second floating diffusion that is shared by the blue photoelectric conversion layer and the red photoelectric conversion layer adjacent to each other in an oblique direction with respect to the column direction.

11. The solid-state imaging device according to claim 10, wherein the first floating diffusion and the second floating diffusion are alternately arranged in each column and in each row.

12. The solid-state imaging device according to claim 1, comprising:
a first floating diffusion that is shared by the first and second green photoelectric conversion layers adjacent to each other in a first oblique direction with respect to the column direction; and
a second floating diffusion that is shared by the blue photoelectric conversion layer and the red photoelectric conversion layer adjacent to each other in a second oblique direction with respect to the column direction.

13. The solid-state imaging device according to claim 12, wherein the first floating diffusion and the second floating diffusion are alternately arranged in the first oblique direction with respect to the column direction.

14. The solid-state imaging device according to claim 1, comprising floating diffusions that are shared by the first and second green photoelectric conversion layers adjacent to each other in the first oblique direction with respect to the column direction and are shared by the blue photoelectric conversion layer and the red photoelectric conversion layer adjacent to each other in the second oblique direction with respect to the column direction.

15. The solid-state imaging device according to claim 14, wherein the floating diffusions are arranged at intervals of one column and at intervals of one row.

16. A solid-state imaging device, comprising a pixel array unit in which pixels for accumulating photoelectric-converted charges are arranged in a matrix in a row direction and a column direction, wherein
the pixel array unit includes a mesh-like arrangement of one set of two green pixels in the first and second green photoelectric conversion layers arranged obliquely with respect to the column direction and one set of two blue and red pixels in the blue photoelectric conversion layer having an area of two pixels that is arranged obliquely with respect to the column direction and in the red photoelectric conversion layer that overlaps the blue photoelectric conversion layer in a depth direction.

17. The solid-state imaging device according to claim 16, comprising vertical signal wires that transmit signals read from the pixels in the column direction.

18. The solid-state imaging device according to claim 16, wherein the set of the first green photoelectric conversion layer and the second green photoelectric conversion layer and the set of the blue photoelectric conversion layer and the red photoelectric conversion layer are alternately arranged in the first oblique direction and the second oblique direction.

19. The solid-state imaging device according to claim 18, comprising floating diffusions that are shared by the first and second green photoelectric conversion layers adjacent to each other in the row direction and are shared by the blue photoelectric conversion layer and the red photoelectric conversion layer adjacent to each other in the column direction.

20. The solid-state imaging device according to claim 19, wherein the floating diffusions are arranged at intervals of one column and at intervals of one row.
